(19) United States
(12) Patent Application Publication
(10) Pub. No.: US 2021/0342370 A1
(43) Pub. Date: Nov. 4, 2021

(54) DYNAMIC PREFERENCE-BASED MATCHING

(71) Applicant: College Engine Inc, Wheaton, IL (US)

(72) Inventors: Jeff Caprini, Wheaton, IL (US); Ross James Kerr, Chicago, IL (US)

(73) Assignee: College Engine Inc, Wheaton, IL (US)

(21) Appl. No.: 16/866,412

(22) Filed: May 4, 2020

(51) Int. Cl. G06F 16/28

(52) U.S. Cl. CPC G06F 16/288

(57) ABSTRACT

A method and system for preference-based matching can receive input data, preference data, and campaign data. Input data can be received from a first interface, and preference data can be associated with the input data. The input data can be ranked based on the preference data. The campaign criteria can be received from a second interface. The input data can be matched to the campaign criteria to create a match list, which can be sorted based on, for example, the preference data.

### TECHNICAL FIELD

The present invention relates to a dynamic algorithmic method and a system for preference-based matching with single-blind privacy protection.

### BACKGROUND

In various contexts, applicants can far outnumber the number of positions available. Applicants often then overapply to multiple entities, including applications to entities of greater and lesser preferability. The entities can then be faced with a glut of applicant spanning a spectrum of desirous to non-desirous of available positions. Present embodiments can address this and other problems.

### SUMMARY

The present invention is generally directed to a system and method for preference-based matching. A computer system executing the method can be directed by a program stored on a non-transitory computer-readable medium. A multi-port interface and distributed computing can be utilized.

An aspect of preference-based matching can include receiving input data, receiving preference data, ranking the input data, receiving campaign criteria, and matching the input data to the campaign criteria. Input data can be received from a first interface, and preference data can be associated with the input data. The input data can be ranked based on the preference data. The campaign criteria can be received from a second interface. The input data can be matched to the campaign criteria to create a match list, which can be sorted based on, for example, the preference data.

Some embodiments can include receiving a set of personal identifying information. Other embodiments can include receiving an acceptance notification and/or sending the personal identifying information to the second interface. Yet other embodiments can include calculating a weighted match list.

Another aspect for preference-based matching can include receiving question inputs, ranking the question inputs, generating a ranked list, receiving a set of campaign preferences, matching the ranked list to the set of campaign preferences, and providing the matched list to a user interface. Question inputs and/or preference inputs can be from a first user interface. Question inputs can be ranked based on, for example, preference inputs, which can be used to generate a ranked list. The set of campaign preferences can come from a second user interface. The ranked list can be matched to the set of campaign preferences to, for example, generate a matched list. The matched list can be provided to the second user interface.

Some embodiments can include receiving a supplemental set of campaign preferences and/or generating a second matched list.

In yet another aspect, a system for preference-based matching can include an n-way cluster of processors, a storage medium, and first and second graphical interfaces. The n-way cluster can be utilized for executing software instructions. The processors can be communicatively coupled to the storage medium. The first and second graphical interfaces can be configured to communicate with the n-way cluster. The software instructions can be executed by the n-way cluster to effectuate the receiving and storing of, for example, input data and preference data from the first graphical interface and to receive and store campaign criteria from a second interface. The software instructions can further configure the n-way cluster to rank the input data based on the preference data and to match the input data to the campaign criteria to create a match list and to sort the match list based on the preference data.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 illustrates an embodiment of a preference-based, single-blind matching method.

FIG. 2 depicts a display of a graphical user interface according to some embodiments.

FIG. 3 depicts a display of a graphical user interface according to some embodiments.

FIG. 4 depicts a display of a graphical user interface according to some embodiments.

FIG. 5 depicts a display of a graphical user interface according to some embodiments.

FIG. 6 depicts a display of a graphical user interface according to some embodiments.

FIG. 7 illustrates a system embodiment for preference-based matching.

### DETAILED DESCRIPTION

A detailed explanation of the system, method, and exemplary embodiments of the present invention are described below. Exemplary embodiments described, shown, and/or disclosed herein are not intended to limit the claims, but rather, are intended to instruct one of ordinary skill in the art as to various aspects of the invention. Other embodiments can be practiced and/or implemented without departing from the scope and spirit of the claimed invention.

The present invention is generally directed to system, device, and method of matching two parties through a weighted, single-blind, bidirectional dynamic algorithm. Embodiments can be highly scalable and can form the basis of various virtual marketplaces. The algorithm can be utilized, for example, to match and therefore connect two entities, such as a buyer and a seller. In an aspect, the algorithm can be utilized to match students with colleges. While systems and methods discussed herein often refer to the context of college applications and admissions, it should be understood that system and method embodiments described are suitable and advantageous to other use cases and contexts, such as any purchaser-seller context, hiring, recruitment, agricultural and industrial supply, art dealers, real estate, online markets, etc. Embodiments can be implemented in these and other contexts without departing from the spirit of the invention and without difficulty by persons having ordinary skill in the art or other skilled artisans, computer programmers, web developers, application developers, etc.

A computer can implement the algorithm and perform functions directed by programs stored in a computer-readable medium. Embodiments cam take the form of hardware, software, or a combination of software and hardware. Embodiments can take the form of a computer-program product that includes computer-useable instructions embodied on one or more computer-readable media.

Techniques, methods, and systems described herein can be implemented in part or in whole using computer-based systems and methods. Additionally, computer-based systems and methods can be used to augment or enhance the functionality, increase the speed at which the functions can be performed, and provide additional features and aspects as a part of or in addition to those described herein.

A dynamic algorithmic method can be utilized for preference-based matching between a student and college. The method can include single-blind privacy protection. For example, the method can include receiving question inputs from a student and ranking question inputs based on preference. The method can include receiving campaign preferences from a college. Matching preference-based inputs from a student to a college can be utilized to create a single-blind match. Single-blind matching can be used to protect students' personal identifying information (“PII”), for example, to prevent sharing the data with a college prior to consent.

A school choice problem can include a set of students each having a profile of preferences and personal constraints, a set of schools each having selection constraints, preference profiles, and priority profiles. A dynamic algorithm can be utilized to maximize preferences on both sides of the student-college divide while accounting for personal and selection constraints. Other benefits of embodiments can include reduced resource demand for candidate selection and improved acceptance rates. Because embodiments can be dynamic, adding new questions to the domain can be seamless with dynamic evaluation and no additional coding if preferred.

A matching engine can be embodied by a general-purpose computer or a server and can have an internal or external memory for storing data and programs such as an operating system (e.g., DOS, Windows2000™, Windows XP™, Windows NT™, Windows7™, Windows 8™, Windows 8.1™, Windows10™, OS/2, UNIX or Linux) and one or more application programs. Examples of application programs can include computer programs implementing the techniques described herein for customization, authoring applications (e.g., word processing programs, database programs, spreadsheet programs, or graphics programs) capable of generating documents or other electronic content; client applications (e.g., an Internet Service Provider (ISP) client, an e-mail client, short message service (SMS) client, or an instant messaging (IM) client) capable of communicating with devices, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP). One or more of the application programs can be installed on the internal or external storage of the general-purpose computer. Alternatively, application programs can be externally stored in or performed by one or more device(s) external to the general-purpose computer.

The general-purpose computer or server may include a central processing unit (CPU) for executing instructions in response to commands, and a communication device for sending and receiving data. One example of the communication device can be a modem. Other examples include a transceiver, a communication card, a satellite dish, an antenna, a network adapter, or some other mechanism capable of transmitting and receiving data over a communications link through a wired or wireless data pathway. A dynamic algorithmic method can be coded in various computer languages. The coding can comprise object oriented, functional, and procedural or other programming styles. Coding can be implemented through C, C++, or any other preferred programming language. Coding can advantageously utilize a plurality of programing languages and styles. Some embodiments can be implemented by utilizing a combination of Java, Python, HTML, and SQL languages. For example, database and server management and querying functionality can advantageously utilize SQL, MySQL, PHP, or CGI. By way of further example, interface functionality can utilize other languages such as HTML and Java. A matching engine can utilize those or other languages better suited to routines with higher computational requirements, such as Python, SimPy, SciPy, C, C++, etc.

The general-purpose computer or server may also include an input/output interface that enables wired or wireless connection to various peripheral devices. In one implementation, a processor-based system of the general-purpose computer can include a main memory, preferably random access memory (RAM), and can also include secondary memory, which may be a tangible computer-readable medium. The tangible computer-readable medium memory can include, for example, a hard disk drive or a removable storage drive, a flash-based storage system or solid-state drive, a floppy disk drive, a magnetic tape drive, an optical disk drive (Blu-Ray, DVD, CD drive), magnetic tape, standalone RAM disks, drive, etc. The removable storage drive can read from or write to a removable storage medium. A removable storage medium can include a floppy disk, magnetic tape, optical disk (Blu-Ray disc, DVD, CD) a memory card (CompactFlash card, Secure Digital card, Memory Stick), etc., which can be removed from the storage drive used to perform read and write operations. As will be appreciated, the removable storage medium can include computer software or data.

In alternative embodiments, the tangible computer-readable medium memory can include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or flash memory) and associated socket, and other removable storage units and interfaces, which allow software and data to be transferred from the removable storage unit to the computer system.

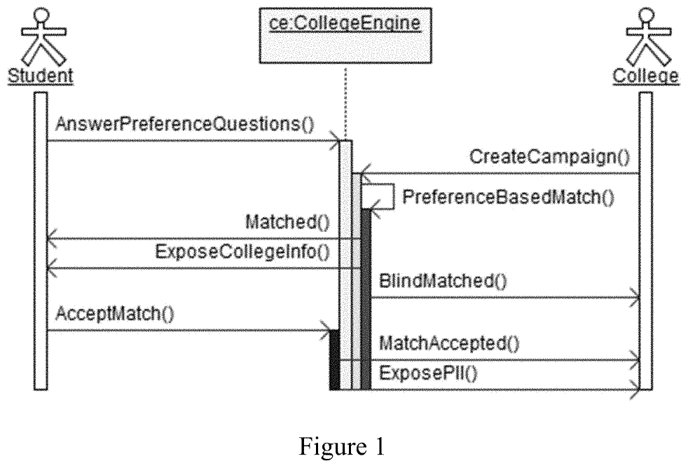

FIG. 1 illustrates an exemplary embodiment of a method. As shown, a matching engine—in this example, “CollegeEngine”—can be architecturally located between a student side and a college side. The matching engine can receive student answers to a set of questions, which can include data such as contact information, personal information, high school information, grades, and college preferences.

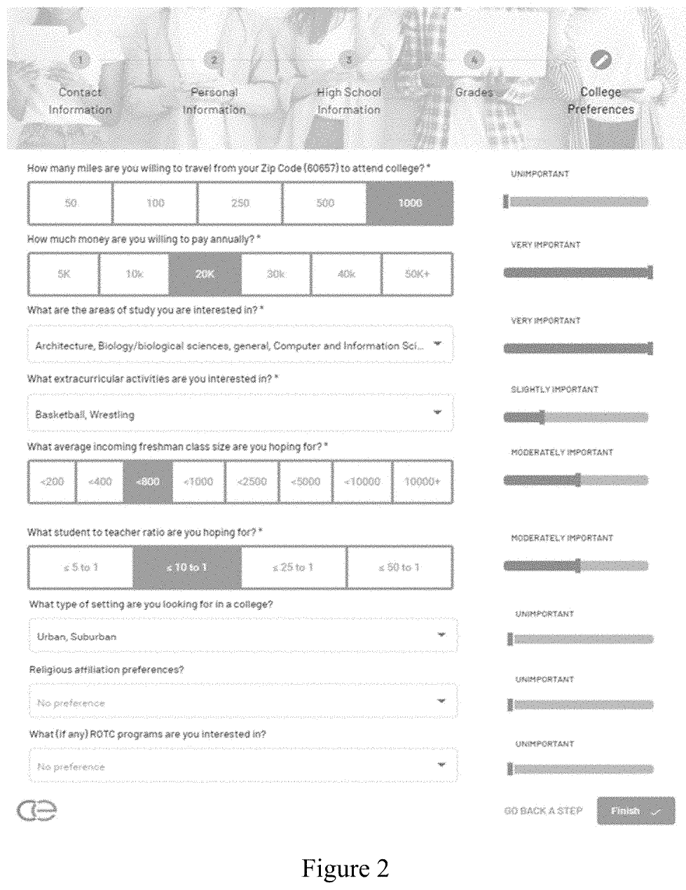

As shown in FIG. 2, college preference data can be elicited through a user interface, such as a graphical user interface (GUI). The GUI can pose series of questions, such as: How many miles are you willing to travel from your ZIP code to attend college? How much money are you willing to pay annually? What are the areas of study you are interested in? What extracurricular activities are you interested in? What average incoming freshman class size are you hoping for? What student to teacher ratio are you hoping for? What type of setting are you looking for in a college (i.e. urban, suburban)? Religious affiliation preference? What (if any) ROTC programs are you interested in? Optionally, the relative strengths of the students' preferences can also be gauges. In the example of FIG. 1, a sliding bar indicator is shown for selecting relative strengths of Unimportant, Very Important, Slightly Important, Moderately Important, but other weighting values can be utilized, such as a one-to-ten scale. Strength selections can be utilized to inform a weighting function by the matching engine. Embodiments also can be leveraged to encourage and utilize so-called “common applications.” Embodiments can include an application repository.

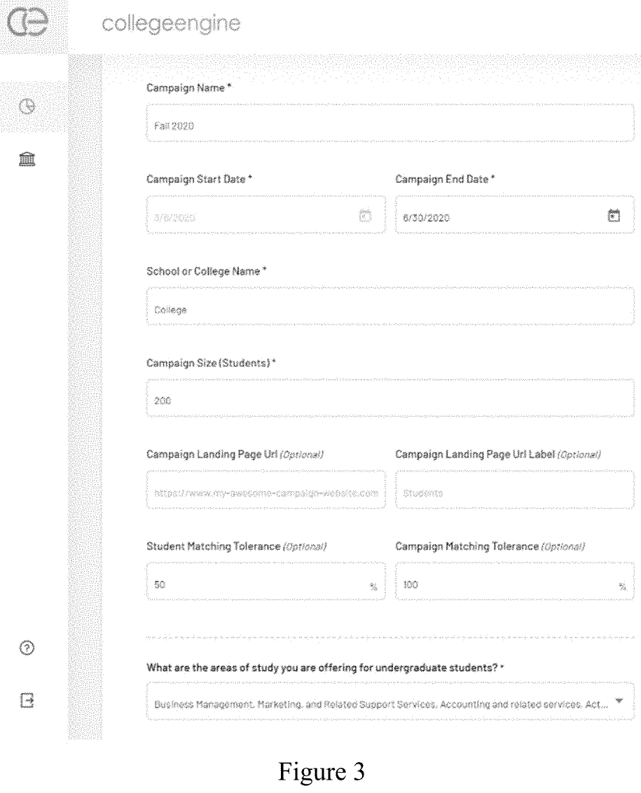

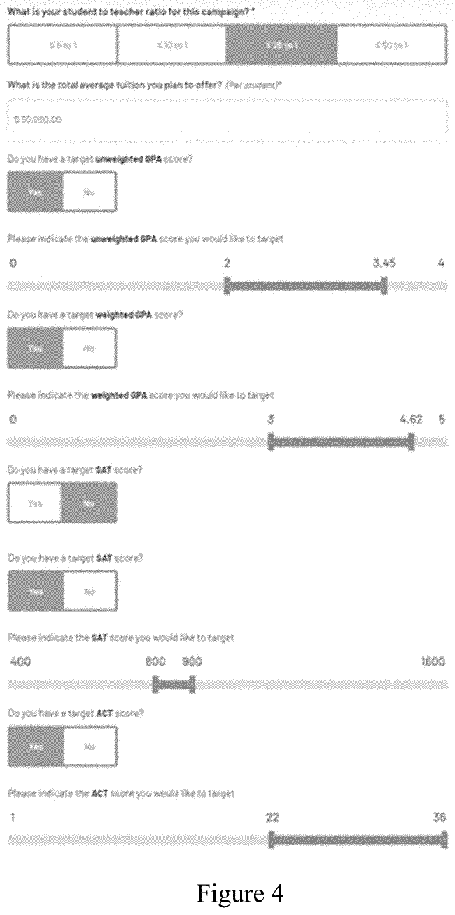

As shown in FIG. 3, a campaign for candidates can be created through a separate user interface. The matching engine can receive candidate selection data, such as campaign name, campaign start date, campaign end date, school or college name, campaign size (students), campaign landing page URL, campaign landing page URL label, student matching tolerance, campaign matching tolerance, As shown in the graphical user interface of FIG. 4, selection data can be elicited through a series of questions, such as: What are the areas of study you are offering for undergraduate students? What is your student to teacher ratio for the campaign? What is the total average tuition you plan to offer? Do you have a target (unweighted GPA score)? Please indicate the unweighted GPA score you would like to consider. Do you have a target weighted GPA? Please indicate the weighted GPA score you would like to target. Do you have a target SAT score? Please indicate your target SAT score. Do you have a target ACT score? Please indicate your target ACT score.

Referring again to FIG. 1, received data can be input to the matching engine. For example, the matching engine can fetch data by calling functions AnswerPreferenceQuestions( ) and CreateCampaign( ) and can initiate matching by calling PreferenceBasedMatch( ). Preliminary steps can include receiving question inputs from a student, ranking question inputs based on preference, receiving campaign preferences from a college, matching preference-based inputs from a student to a college creating a single-blind match, and protecting student PII data from being shared with a college prior to consent.

Steps within the exemplary PreferenceBasedMatch( ) function can include various subroutines. Data elements can be changed to student questions or campaign, as detected dynamically. Matching can be rerun only for changed student or campaign data elements. A match element list (MEL) can be calculated from changes and can be published to a match element engine (MEE). Matches can be dispatched against MEL dynamically, for example based on question types, which can include data such as range, list, number, and distance based on ZIP code. A match weight can be calculated against MEL, for example based on match result and preference.

Various additional subroutines can be performed in parallel within the exemplary PreferenceBaseMatch( ) function, including calculating student match percentages and campaign match percentages. Student match percentages can be determined by calculating a maximum match total (MMTₛ) for a student, calculating an actual match total (AMTₛ) for a student, and calculating match percentages for a student. The match percentages for students can take the form:

ƒₛ=AMTₛ/MMTₛ

The campaign match percentages can be determined by calculating a maximum match total (MMT_{c}) for the college, calculating an actual match total (AMT_{c}) for the college, and calculating a match percentage for the College, which can take the form:

ƒ_{c}=AMT_{c}/MMT_{c}

Other additional subroutines can be performed in parallel within the exemplary PreferenceBaseMatch( ) function. For example, students with student match percentage below a student match tolerance can be identified with a data structure or data element, such as not matched. Such data can be used for discarding applicants or other steps. Campaigns with campaign match percentages less than a campaign match tolerance can similarly discarded or otherwise further processed by associating such campaign match percentages with the not matched data structure or element. Students and campaigns not associated with the not matched data can be marked as matched and can be included in a list, such as MatchList.

Exemplary functions Matched( ) and ExposeCollegeInfo( ) can be utilized for single-blind matching. A MatchList can be published and all students in MatchList can be notified of a match through a user interface, such as a GUI and a mobile device or other computer. Notifications can be in the form of an SMS, an IM, or can optionally be provided only when a logging in event occurs. Upon instances of matching, college and campaign information can be exposed to students. To protect the students' PII, students can be offered an option to accept or decline any matching. Lists, AcceptMatch and DeclineMatch, or other containers can be utilized to store elements associated with student choices to decline or accept.

The matching engine can register accepted matches via exemplary function AcceptMatch( ) Upon acceptance of a match, the matching engine can register the accepted match and can facilitate the exposure of student PII data to the accepted college.

Preferred embodiments can include a distributed computing environment. Although single-blind dynamic matching need not be computationally burdensome, both scaling and the complexity of matching criteria (such as weighting and optimization) can increase computational demands. Seasonal or other time delimited contexts can also tax processing availability at critical times. For example, in the context of college applications and admissions, applicants and colleges across the country and even the world begin and complete the vast majority of the process over the course of a few months. The combinatorial nature of matching can lead to challenges when scaling. Embodiments can be designed to meet such challenges. A Beowulf cluster can be implemented to perform parallel processing fat moderate scales. For small to large scaling, a Hadoop cluster is preferred as they can store and analyze huge amounts of structured and unstructured data in a distributed computing environment. Further, coding the algorithm for an n-way cluster can be advantageous to allow for increased and decreased computational capacity as needed. Additional features can be included to improve scalability, for example by implementing a design architecture based on distributed message queuing and distributed data storage. A distributed message queuing system can generate data that can be delivered to a particular queue for consumption or processing by an event notifier that monitors the queue.

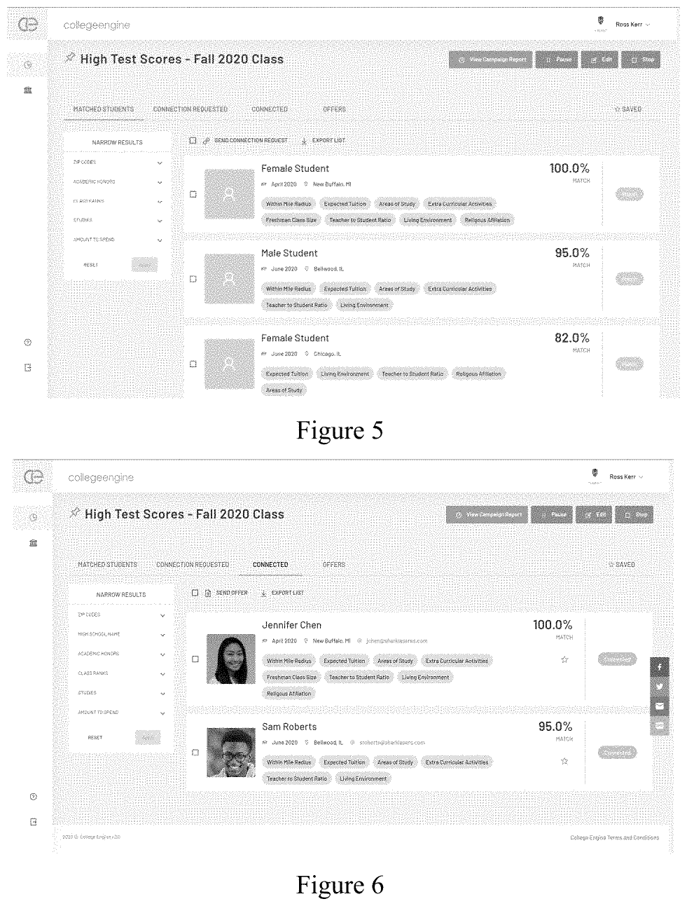

FIGS. 5 and 6 depict examples of college-side graphical user interfaces. The two figures highlight examples of pre-acceptance and post-acceptance views of student candidates. The data conveyed by the matching engine in the graphical interface of FIG. 5 can be tailored to provide all of the information necessary for the college to make its offer decisions but at the same time prevents the students' PPI data from being exposed to the college. FIG. 6 on the other hand depicts a list of candidates who have accepted the match, and thus can include student PPI data.

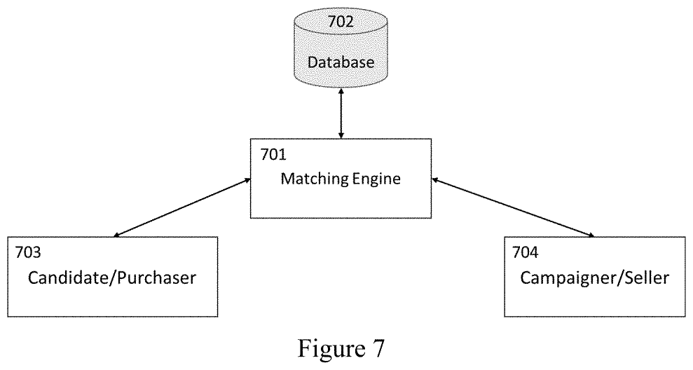

FIG. 7 illustrates a system embodiment. The system includes a matching engine (701), a database (702), a student side interface (703), and a college side interface (704). In some embodiments, the algorithm can be stored in a memory or storage device such as those discussed above. The matching engine can include one or more processors and can be implemented via a computer, a cloud-based system, a server, or other devices.

The server can include the general-purpose computer discussed above. The matching engine can be implemented within a network, for example, the Internet, the World Wide Web, WANs, LANs, analog or digital wired and wireless networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link can include communication pathways that enable communications through one or more networks.

All of the methods and systems disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope or the invention. In addition, from the foregoing it will be seen that this invention is one well adapted to attain all the ends and objects set forth above, together with other advantages. It will be understood that certain features and sub-combinations are of utility and may be employed without reference to other features and sub-combinations. This is contemplated and within the scope of the appended claims. All such similar substitutes and modifications apparent to those skilled in the art are deemed to be within the spirit and scope of the invention as defined by the appended claims.

1. A method for preference-based matching, comprising:
receiving input data from a first interface;
receiving preference data associated with the input data;
ranking the input data based on the preference data;
receiving campaign criteria from a second interface; and
matching the input data to the campaign criteria to create a match list and sorting the match list based on the preference data.

2. The method of claim 1, further comprising receiving a set of personal identifying information.

3. The method of claim 2, further comprising receiving an acceptance notification and sending the personal identifying information to the second interface.

4. The method of claim 1, further comprising calculating a weighted match list.

5. A method for preference-based matching, comprising:
receiving question inputs from a first user interface;
ranking the question inputs based on preference inputs to generate a ranked list;
receiving a set of campaign preferences from a second user interface;
matching the ranked list to the set of campaign preferences to generate a matched list;
providing the matched list to the second user interface.

6. The method of claim 5, further comprising receiving a supplemental set of campaign preferences and generating a second matched list.

7. A system for preference-based matching, comprising:
an n-way cluster of processors for executing software instructions, wherein the n-way cluster is communicatively coupled to a storage medium;
a first graphical interface and a second graphical interface, wherein the first and the second graphical interfaces are configured to communicate with the n-way cluster;
wherein the software instructions configure the n-way cluster to receive and store input data and preference data from the first graphical interface and to receive and store campaign criteria from a second interface; and
wherein the software instructions further configure the n-way cluster to rank the input data based on the preference data and to match the input data to the campaign criteria to create a match list and to sort the match list based on the preference data.
